(19) United States
(12) Patent Application Publication
(10) Pub. No.: US 2024/0207823 A1
(43) Pub. Date: Jun. 27, 2024

(54) LAYERED CATALYTIC ARTICLE

(71) Applicant: BASF Corporation, Florham Park, NJ (US)

(72) Inventors: Wei Liang Wang, Shanghai (CN); Xiaolai Zheng, Iselin, NJ (US); Chun Yu chen, Shanghai (CN); Attilio Siani, Hannover (DE); Pascaline Tran, Iselin, NJ (US)

(73) Assignee: BASF Corporation, Florham Park, NJ (US)

(21) Appl. No.: 18/555,770

(22) PCT Filed: Apr. 20, 2022
(86) PCT No.: PCT/CN2022/087933

§ 371 Date: Oct. 17, 2023

(30) Foreign Application Priority Data
Apr. 21, 2021 (WO) PCT/CN2021/088742

(51) Int. Cl. B01J 23/42; B01D 53/94; B01J 23/10; B01J 35/00

(52) U.S. Cl. CPC B01J 23/42; B01D 53/945; B01J 23/10; B01J 35/19; B01D 2255/9155; B01D 2257/404; B01D 2257/502; B01D 2257/702; B01D 2258/012

(57) ABSTRACT

The present invention relates to a layered catalytic article, particularly useful for three-way conversion, which comprises a) atop layer comprising a palladium (Pd) component, a platinum (Pt) component and a rhodium (Rh) component, wherein the palladium component, the platinum component and the rhodium component are present in supported forms, and wherein at least part of the platinum component and at least part of the rhodium component are supported together on one or more supports; b) a bottom layer comprising a palladium component in a supported form as the only platinum group metal component; and c) a substrate, on which the top layer and bottom layer are carried, wherein the palladium components are loaded in the top layer and in the bottom layer at a ratio of higher than 1:1, calculated as palladium element, and also to an exhaust treatment system comprising the same.

### FIELD OF THE INVENTION

The present invention relates to a layered Pt/Pd/Rh tri-metal catalytic article, an exhaust treatment system comprising the same and a method for treating an exhaust stream with the layered catalytic article or the exhaust treatment system.

### BACKGROUND OF THE INVENTION

In order to meet emission standards for unburned hydrocarbons (HC), carbon monoxide (CO) and nitrogen oxides (NOx, such as NO and/or NO₂) contaminants, catalytic converters containing a three-way conversion (TWC) catalyst (hereinafter interchangeably referred to as TWC catalyst, or TWC) have been utilized for several years. TWC catalysts are well known to simultaneously oxidize unburnt hydrocarbons and carbon monoxide and reduce nitrogen oxides in the exhaust streams from internal combustion engines, especially gasoline engines.

TWC catalysts utilize platinum group metals (PGMs) as the catalytic active species. In particular, palladium is typically used as the major platinum group metal together with a minor amount of rhodium. In recent years, a great challenge in the field of TWC catalysts is the increasing manufacturing cost, since an acute supply shortage of palladium in the market drove a continuous growth of palladium price, which is approximately 2.6 times higher than that of platinum now. At the same time, the platinum price is expected to be decreased due to decreasing production volumes of diesel-powered vehicles which typically use diesel oxidation catalysts containing platinum as the major catalytic active species. Accordingly, TWC catalysts comprising platinum in place of at least a portion of palladium are desirable to reduce the cost of the catalyst substantially. However, it is expected that simple replacement of palladium with platinum will result in undesirable or unsatisfactory performance of the catalyst. Various TWC catalysts comprising an amount of platinum have been developed in the past few decades.

With more and more stringent regulations on engine exhaust emission, there is a continuing need to provide TWC catalysts which provide efficient removal of HC, CO and NOx and can be produced with reduced cost.

### SUMMARY OF THE INVENTION

The object of the present invention is to provide a catalytic article comprising platinum in replace of an amount of palladium used otherwise in TWC catalysts, which has comparable or even improved overall catalytic performance in terms of abatement of HC, CO and NOx.

Accordingly, the present invention provides a layered catalytic article, which comprises:
a) a top layer comprising a palladium component, a platinum component and a rhodium component, wherein the palladium component, the platinum component and the rhodium component are present in supported forms, and wherein at least part of the platinum component and at least part of the rhodium component are supported together on one or more supports;
b) a bottom layer comprising a palladium component in a supported form as the only platinum group metal component; and
c) a substrate, on which the top layer and bottom layer are carried, wherein the palladium components are loaded in the top layer and in the bottom layer at a ratio of higher than 1:1, calculated as palladium element.

In another aspect, the present invention provides an exhaust treatment system comprising the layered catalytic article as described herein located downstream of an internal combustion engine.

In a further aspect, the present invention provides a method for treating an exhaust stream including contacting the exhaust stream with the layered catalytic article or the exhaust treatment system as described herein.

### BRIEF DESCRIPTION OF THE DRAWINGS

FIG. 1A is a schematic diagram of Pd/Rh bi-metal catalytic article with an exemplary layered configuration as prepared according to Example 1;

FIG. 1B is a schematic diagram of Pd/Pt/Rh tri-metal catalytic article with an exemplary layered configuration as prepared according to Example 2;

FIG. 1C is a schematic diagram of Pd/Pt/Rh tri-metal catalytic article with an exemplary layered configuration as prepared according to Example 3;

FIGS. 2A, 2B, 2C and 2D are schematic diagrams of Pd/Pt/Rh tri-metal catalytic articles with exemplary layered configurations as prepared according to Examples 4, 5, 6 and 7 respectively;

FIGS. 3A and 3B are schematic diagrams of Pd/Pt/Rh tri-metal catalytic articles with exemplary layered configurations as prepared according to Example 8 and 9 respectively;

FIG. 4 is schematic diagrams of Pd/Pt/Rh tri-metal catalytic articles with an exemplary layered configuration as prepared according to Example 10;

FIG. 5 is a schematic diagram of Pd/Pt/Rh tri-metal catalytic article with an exemplary layered configuration as prepared according to Example 11;

FIG. 6 is a schematic diagram of Pd/Pt/Rh tri-metal catalytic article with an exemplary layered configuration as prepared according to Example 12;

FIG. 7 is a graph showing tail-pipe HC emissions after treatment of exhaust with the catalytic articles according to the Examples;

FIG. 8 is a graph showing tail-pipe CO emissions after treatment of exhaust with the catalytic articles according to the Examples;

FIG. 9 is a graph showing tail-pipe NOx emissions after treatment of exhaust with the catalytic articles according to the Examples.

### DETAILED DESCRIPTION OF THE INVENTION

The present invention will be described in details hereinafter. It is to be understood that the present invention may be embodied in many different ways and shall not be construed as limited to the embodiments set forth herein.

The singular forms “a”, “an” and “the” include plural referents unless the context clearly dictates otherwise. The terms “comprise”, “comprising”, etc. are used interchangeably with “contain”, “containing”, etc. and are to be interpreted in a non-limiting, open manner. That is, e.g., further components or elements may be present. The expressions “consists of” or “consists essentially of” or cognates may be embraced within “comprises” or cognates.

According to one aspect of the present invention, a layered catalytic article is provided, which comprises:
a) a top layer comprising a palladium (Pd) component, a platinum (Pt) component and a rhodium (Rh) component, wherein the palladium component, the platinum component and the rhodium component are present in supported forms, and wherein at least part of the platinum component and at least part of the rhodium component are supported together on one or more supports;
b) a bottom layer comprising a palladium component in a supported form as the only platinum group metal component; and
c) a substrate, on which the top layer and bottom layer are carried, wherein the palladium components are loaded in the top layer and in the bottom layer at a ratio of higher than 1:1, calculated as palladium element.

The layered catalytic article according to the present invention is particularly effective as a TWC catalyst.

The terms “palladium component”, “platinum component” and “rhodium component” as used herein are intended to describe the presence of those platinum group metals in any possible valence state, which may be for example respective metals or metal oxides as the catalytically active form, or may be for example respective metal compounds, complexes, or the like which, upon calcination or use of the catalyst, decompose or otherwise convert to the catalytically active form.

The term “layered catalytic article” as used herein refers to a catalytic article comprising catalyst compositions coated on a substrate in a layered design.

In some embodiments, the top layer in the layered catalytic article according to the present invention is substantially free of any PGMs other than Pd, Pt and Rh. Herein, reference to “substantially free” is intended to mean no PGM other than Pd, Pt and Rh has been intentionally added or used in the layer. It will be appreciated by those of skill in the art that a trace amount of PGM(s) other than Pd, Pt and Rh may be present as impurity in the top layer.

The bottom layer in the layered catalytic article according to the present invention does not comprise any PGMs other than Pd that has been intentionally added or used in the layer. Also, a trace amount of PGM(s) other than Pd may be present as impurity in the bottom layer.

The trace amount of impurity PGM(s) may originate from raw materials for preparing respective layers, and/or may originate from migration of PGM(s) into the layer that may occur during loading, coating and/or calcining in the process of preparing the catalytic article.

Herein, “trace amount” of PGM(s) means no more than 1 wt %, including no more than 0.75 wt %, no more than 0.5 wt %, no more than 0.25 wt %, or no more than 0.1 wt %, based on the total loading of PGMs in a layer.

Herein, reference to a platinum group metal in “supported form” is intended to mean that the platinum group metal is supported on and/or in a support in form of particles. Reference to the platinum and rhodium components “supported together” is intended to mean the two platinum group metals are supported on and/in the same support particles, for example by means of impregnation of respective precursors on the support particles simultaneously or sequentially. It will be appreciated that both platinum and rhodium may be found on and/in a single particle of the support if platinum and rhodium components are supported together.

The term “support” refers to a material for receiving and carrying a catalytically active component such as the platinum group metal(s), and optionally one or more other components such as stabilizers, promoters and binders. The support may be selected from refractory metal oxides, oxygen storage components and any combinations thereof.

The refractory metal oxide, a widely used support for the platinum group metals in exhaust treatment catalytic articles, is generally a high surface area alumina-based material, zirconia-based material or a combination thereof. Within the context of the present invention, “alumina-based material” refers to a material comprising alumina as the base and optionally a dopant. Similarly, “zirconia-based material” refers to a material comprising zirconia as the base and optionally a dopant.

Suitable examples of the alumina-based materials include, but are not limited to alumina, for example a mixture of the gamma and delta phases of alumina which may also contain substantial amounts of eta, kappa and theta alumina phases, lanthana doped alumina, baria doped alumina, ceria doped alumina, zirconia doped alumina, ceria-zirconia doped alumina, lanthana-zirconia doped alumina, baria-lanthana doped alumina, baria-lanthana-neodymia doped alumina, and any combinations thereof.

Suitable examples of the zirconia-based materials include, but are not limited to zirconia, alumina doped zirconia, lanthana doped zirconia, yttria doped zirconia, neodymia doped zirconia, praseodymia doped zirconia, titania doped zirconia, titania-lanthana doped zirconia, lanthana-yttria doped zirconia, and any combinations thereof.

For example, the refractory metal oxide is selected from alumina, lanthana doped alumina, lanthana-zirconia doped alumina, ceria doped alumina, zirconia doped alumina, ceria-zirconia doped alumina, zirconia, alumina doped zirconia, lanthana doped zirconia, lanthana-yttria doped zirconia, and any combinations thereof.

Generally, the amount of the refractory metal oxide is 10 to 90 wt. %, if used, based on the total weight of the bottom or top layer.

The oxygen storage component (OSC) refers to an entity that has a multi-valence state and can actively react with oxidants such as oxygen or nitrogen oxides under oxidative conditions, or reacts with reductants such as carbon monoxide (CO) or hydrogen under reduction conditions. Typically, the OSC comprise one or more reducible rare earth metal oxides, such as ceria. The OSC may also comprise one or more of lanthana, praseodymia, neodymia, europia, samaria, ytterbia, yttria, zirconia, hafnia to constitute a composite oxide with ceria. Preferably, the oxygen storage component is selected from ceria-zirconia composite oxide and rare earth-stabilized ceria-zirconia composite oxide.

Generally, the amount of oxygen storage component is 20 to 80 wt. %, if used, based on the total weight of the bottom or top layer.

Within the context of the present invention, there is no particular restriction to the support for the palladium component in the top and bottom layers. The palladium components may be supported on a refractory metal oxide, an oxygen storage component or any combination thereof. In some embodiments, the palladium components may be supported on one or more supports selected from refractory metal oxides selected from alumina-based materials and zirconia-based materials, and oxygen storage components.

Preferably, the palladium component in the top layer may be supported on one or more supports selected from alumina, lanthana doped alumina, baria doped alumina, ceria doped alumina, zirconia doped alumina, ceria-zirconia doped alumina, lanthana-zirconia doped alumina, baria-lanthana doped alumina, baria-lanthana-neodymia doped alumina, zirconia, lanthana doped zirconia, yttria doped zirconia, neodymia doped zirconia, praseodymia doped zirconia, titania doped zirconia, titania-lanthana doped zirconia, lanthana-yttria doped zirconia, ceria, ceria-zirconia composite oxide and rare earth-stabilized ceria-zirconia composite oxide, more preferably one or more selected from alumina, ceria-zirconia composite oxide and rare earth-stabilized ceria-zirconia composite oxide.

Additionally or alternatively, it is preferred that the palladium component in the bottom layer may be supported on one or more supports selected from alumina, lanthana doped alumina, baria doped alumina, ceria doped alumina, zirconia doped alumina, ceria-zirconia doped alumina, lanthana-zirconia doped alumina, baria-lanthana doped alumina, baria-lanthana-neodymia doped alumina, ceria, ceria-zirconia composite oxide and rare earth-stabilized ceria-zirconia composite oxide, more preferably one or more selected from alumina, ceria-zirconia composite oxide and rare earth-stabilized ceria-zirconia composite oxide.

It will be appreciated that the supports for the palladium components in the top layer and in the bottom layer may be selected independently from each other. That is, the support for the palladium component in the top layer may be same or different from the support for the palladium component in the bottom layer.

Within the context of the present invention, it will be desirable that the at least part of the platinum component and the at least part of the rhodium component in the top layer are supported together on one or more supports other than alumina.

In some embodiments, the at least part of the platinum component and the at least part of the rhodium component may be supported together on one or more supports selected from ceria doped alumina, zirconia doped alumina, ceria-zirconia doped alumina, lanthana-zirconia doped alumina, baria-lanthana doped alumina, baria-lanthana-neodymia doped alumina, zirconia, lanthana doped zirconia, yttria doped zirconia, neodymia doped zirconia, praseodymia doped zirconia, titania doped zirconia, titania-lanthana doped zirconia, lanthana-yttria doped zirconia, ceria, ceria-zirconia composite oxide and rare earth-stabilized ceria-zirconia composite oxide. Preferably, the at least part of the platinum component and the at least part of the rhodium component may be supported on one or more supports selected from ceria doped alumina, ceria-zirconia composite oxide and rare earth-stabilized ceria-zirconia composite oxide.

There is no particular restriction to the support for the remaining part, i.e., the individually supported part of the platinum component, if present. The support for the individually supported part of the platinum component may be one or more selected from alumina-based materials and zirconia-based materials, and oxygen storage components as defined hereinabove for the palladium component.

There is no particular restriction to the support for the remaining part, i.e., the individually supported part of the rhodium component, if present. In some embodiments, the support for the individually supported part of the rhodium component may be one or more selected from alumina, ceria doped alumina, zirconia doped alumina, ceria-zirconia doped alumina, lanthana-zirconia doped alumina, baria-lanthana doped alumina, zirconia, alumina doped zirconia, lanthana doped zirconia, yttria doped zirconia, neodymia doped zirconia, praseodymia doped zirconia, titania doped zirconia, titania-lanthana doped zirconia, lanthana-yttria doped zirconia, baria-lanthana-neodymia doped alumina, ceria, ceria-zirconia composite oxide and rare earth-stabilized ceria-zirconia composite oxide. Preferably, the rhodium component, when individually supported, may be supported on one or more supports selected from zirconia doped alumina, ceria-zirconia doped alumina, zirconia, alumina doped zirconia, lanthana doped zirconia, yttria doped zirconia, neodymia doped zirconia, praseodymia doped zirconia, titania doped zirconia, titania-lanthana doped zirconia, lanthana-yttria doped zirconia.

In some embodiments, the part of the platinum component that is supported together with the at least part of the rhodium component may account for at least 70%, for example at least 85% of the total amount of the platinum component. Particularly, all of the platinum component is supported together with the at least part of the rhodium component on one or more supports in the top layer.

In some embodiments, all the rhodium component is supported together with the platinum component on one or more supports. In other embodiments, a part of the rhodium component is supported together with the platinum component on one or more supports and the remaining part of the rhodium component is supported individually on one or more supports.

In the latter embodiments, the part of the rhodium component that is supported together with the platinum component may account for at least 10%, at least 30%, at least 50% of the total rhodium component.

In some particular embodiments, the palladium components are loaded in the top layer and in the bottom layer at a ratio of higher than 1:1 and no greater than 10:1, preferably in the range of 1.2:1 to 6:1, more preferably 1.5:1 to 4:1, most preferably in the range of 2:1 to 4:1, for example 2.5:1 or 3:1, calculated as palladium element.

The weight ratio of the palladium component to the platinum component comprised in the layered catalytic article according to the present invention may vary in the range of 1:1 to 10:1, calculated as palladium and platinum elements. For example, the weight ratio of the palladium component to the platinum component comprised in the layered catalytic article may be no less than 2.0:1, no less than 2.1:1, no less than 2.3:1. The weight ratio of the palladium component to the platinum component comprised in the layered catalytic article may be no greater than 9:1, no greater than 6:1, or no greater than 5:1, or no greater than 4:1. Accordingly, in some preferable embodiments, the palladium component and the platinum component may be comprised in the layered catalytic article according to the present invention at a Pd/Pt weight ratio calculated as palladium and platinum elements in the range of 2.0:1 to 9:1, 2.1:1 to 6:1, 2.3:1 to 5:1, or 2.3:1 to 4:1.

There is no particular restriction to the weight ratio of rhodium component to the palladium component, the weight ratio of rhodium component to the platinum component or the sum of the palladium and platinum components in the layered catalytic article according to the present invention. For example, the weight ratio of the rhodium component to the sum of the palladium and platinum components in the layered catalytic article according to the present invention may be in the range of 2:3 to 1:200, 1:2 to 1:50, 1:3 to 1:20, or 1:3 to 1:10, calculated as respective elements.

The weight ratio of the palladium component to the platinum component to the rhodium component in the layered catalytic article according to the present invention may be for example in the range of 1:1:1 to 10:1:0.2, 2:1:1 to 9:1:0.3, or 2:1:1 to 5:1:0.5, calculated as respective elements.

Generally, the platinum group metals may be loaded in the top layer in an amount of 1 to 250 g/ft³, 5 to 150 g/ft³, or 5 to 100 g/ft³, calculated as the sum of respective elements. Additionally or alternatively, the palladium component may be loaded in the bottom layer in an amount of 0.5 to 200 g/ft³, 1 to 150 g/ft³, or 2 to 100 g/ft³, calculated as palladium element.

The total loading of the top layer may be in the range of 1.5 to 4.0 g/in³ or 1.5 to 3 g/in³ and the total loading of the bottom layer may be in the range of 0.75 to 3.0 g/in³ or 1.0 to 2.5 g/in³.

In some illustrative embodiments, the layered catalytic article according to the present invention comprises:
a) a top layer comprising a palladium component, a platinum component and a rhodium component, wherein the palladium component, the platinum component and the rhodium component are present in supported forms, and wherein all of the platinum component and at least part of the rhodium component are supported together on one or more supports selected from ceria doped alumina, zirconia doped alumina, ceria-zirconia doped alumina, lanthana-zirconia doped alumina, baria-lanthana doped alumina, baria-lanthana-neodymia doped alumina, zirconia, lanthana doped zirconia, yttria doped zirconia, neodymia doped zirconia, praseodymia doped zirconia, titania doped zirconia, titania-lanthana doped zirconia, lanthana-yttria doped zirconia, ceria, ceria-zirconia composite oxide and rare earth-stabilized ceria-zirconia composite oxide;
b) a bottom layer comprising a palladium component in a supported form as the only platinum group metal component; and
c) a substrate, on which the top layer and bottom layer are carried,
wherein the palladium components are loaded in the top layer and in the bottom layer at a ratio in the range of 1.2:1 to 6:1, preferably 1.5:1 to 4:1, more preferably in the range of 2:1 to 4:1, calculated as palladium element.

In further illustrative embodiments, the layered catalytic article according to the present invention comprises:
a) a top layer comprising a palladium component, a platinum component and a rhodium component, wherein the palladium component, all of the platinum component and the rhodium component are present in supported forms, and wherein the platinum component and at least part of the rhodium component are supported together on one or more supports selected from ceria doped alumina, ceria-zirconia composite oxide and rare earth-stabilized ceria-zirconia composite oxide;
b) a bottom layer comprising a palladium component in a supported form as the only platinum group metal component; and
c) a substrate, on which the top layer and bottom layer are carried,
wherein the palladium components are loaded in the top layer and in the bottom layer at a ratio in the range of 1.5:1 to 4:1, preferably in the range of 2:1 to 4:1, calculated as palladium element.

Preferably, in each of the illustrative embodiments as described above, the part of the rhodium component that is supported together with the platinum component may account for at least 30%, at least 50% of the total rhodium component.

More preferably, in each of the illustrative embodiments as described above, the rhodium component, when individually supported, is supported on one or more supports selected from zirconia doped alumina, ceria-zirconia doped alumina, zirconia, alumina doped zirconia, lanthana doped zirconia, yttria doped zirconia, neodymia doped zirconia, praseodymia doped zirconia, titania doped zirconia, titania-lanthana doped zirconia, lanthana-yttria doped zirconia.

In some particular embodiments of the layered catalytic article according to the present invention, the bottom layer is applied on the substrate and the top layer is applied on the bottom layer without any intermediate layer.

The term “substrate” as used herein refers to a structure that is suitable for withstanding conditions encountered in exhaust streams of combustion engines on which the catalytic compositions carried, typically in the form of a washcoat. The substrate is generally a ceramic or metal honeycomb structure having fine, parallel gas flow passages extending from one end of the structure to the other.

The term “washcoat” has its usual meaning in the art and refers to a thin, adherent coating of a catalytic or other material applied to a substrate. A washcoat is generally formed by preparing a slurry containing a certain solid content (e.g., 15-60% by weight) of particles in a liquid vehicle, which is then applied onto a substrate, dried and calcined to provide a washcoat layer.

Metal materials useful for constructing the substrate may include heat resistant metals and metal alloys such as titanium and stainless steel as well as other alloys in which iron is a substantial or major component. Such alloys may contain one or more nickel, chromium, and/or aluminium, and the total amount of these metals may advantageously comprise at least 15 wt % of the alloy. e.g. 10 to 25 wt % of chromium, 3 to 8% of aluminium, and up to 20 wt % of nickel. The alloys may also contain small or trace amounts of one or more metals such as manganese, copper, vanadium, titanium and the like. The surface of the metal substrate may be oxidized at high temperature, e.g., 1000° C. and higher, to form an oxide layer on the surface of the substrate, improving the corrosion resistance of the alloy and facilitating adhesion of the washcoat layer to the metal surface.

Ceramic materials useful for constructing the substrate may include any suitable refractory material, e.g., cordierite, mullite, cordierite-alumina, silicon nitride, zircon mullite, spodumene, alumina-silica-magnesia, zircon silicate, sillimanite, magnesium silicates, zircon, petalite, alumina, and aluminosilicates.

Within the context of the present invention, a monolithic flow-through substrate is preferred, which has a plurality of fine, parallel gas flow passages extending from an inlet to an outlet face of the substrate such that passages are open to fluid flow therethrough. The passages, which are essentially straight paths from their fluid inlet to their fluid outlet, are defined by walls on which the catalytic material is applied as a washcoat so that the gases flowing through the passages contact the catalytic material. The flow passages of the monolithic substrate are thin-walled channels, which can be of any suitable cross-sectional shape and size such as trapezoidal, rectangular, square, sinusoidal, hexagonal, oval, circular, etc. Such structures may contain from about 60 to about 900 or more gas inlet openings (i.e., cells) per square inch of cross section. For example, the substrate may have from about 400 to 900, more usually from about 600 to 750, cells per square inch (“cpsi”). The wall thickness of flow-through substrates may vary, with a typical range from 2 mils to 0.1 inches. A representative flow-through substrate is a cordierite substrate having a cell density of 600 cpsi or 750 cpsi and a wall thickness of 2 mils.

It is also possible that the substrate is a wall-flow substrate having a plurality of fine, parallel gas flow passages extending along from an inlet to an outlet face of the substrate wherein alternate passages are blocked at opposite ends. The configuration requires the gas stream flow through the porous walls of the wall-flow substrate to reach the outlet face. The wall-flow substrates may contain up to about 700 cells per square inch (cpsi), for example about 100 to 400 cpsi and more typically about 200 to about 300 cpsi. The cross-sectional shape of the cells can vary as described above. The flow passages of the monolithic substrate are thin-walled channels, which can be of any suitable cross-sectional shape and size such as trapezoidal, rectangular, square, sinusoidal, hexagonal, oval, circular, etc. The wall thickness of wall-flow substrates may vary, with a typical range from 2 mils to 0.1 inches.

The layered catalytic article according to the present invention may be prepared conventionally, for example by a process including depositing a bottom coat slurry to obtain a bottom layer, and subsequently depositing a top coat slurry to obtain a top layer.

Generally, the slurries comprise catalytic particles, a solvent (e.g. water), an optional binder and an optional auxiliary such as surfactant, pH adjustor and thickener. Particularly, the bottom coat slurry comprises the palladium component in supported form as the catalytic particles, and the top coat slurry comprises, as catalytic particles, the palladium component in supported form, the platinum and rhodium components supported together, and optionally the platinum and/or rhodium component supported individually. The supports for the PGMs are as descried herein above.

Those catalytic particles may be prepared by impregnating precursors of the PGM(s) such as soluble salts and/or complexes thereof via conventional techniques such as dry impregnation (also called incipient wetness impregnation or capillary impregnation) or wet impregnation on respective supports, optionally followed by drying and/or calcining. Suitable precursors of the PGMs may be selected from ammine complex salts, hydroxyl salts, nitrates, carboxylic acid salts, ammonium salts, oxides and colloids of PGMs. Non-limiting examples include palladium nitrate, tetraammine palladium nitrate, rhodium nitrate, tetraammine platinum acetate, platinum nitrate, tetraammine platinum acetate, hexahydroxyplatinic acid diethanolamine salt ((HOCH₂CH₂NH₃)₂[Pt(OH)₆]) and colloidal platinum.

The binder may be selected from alumina, boehmite, silica, zirconium acetate, colloidal zirconia, or zirconium hydroxide. When present, the binder is typically used in an amount of about 0.5 to about 5.0 wt % of the total washcoat loading.

The slurries may have a solid content for example in the range of about 20 to 60 wt %, more particularly about 30 to 50 wt. %. The slurries are often milled to reduce the particle size. Typically, the slurries will have a D₉₀ particle size of about 3.0 to about 40 microns, preferably about 10 to about 30 microns, more preferably less than about 20 microns, after milling, as measured by laser diffraction particle size distribution analyzer.

Deposition of the slurries on the substrate or on the underlying coat may be carried out via any techniques known in the art. For example, the substrate may be dipped one or more times in a slurry or coated otherwise with a slurry to a desired length, and then dried at an elevated temperature (e.g., 100 to 150° C.) for a period (e.g., 10 minutes to 3 hours) and calcined at a higher temperature (e.g., 400 to 700° C.) typically for about 10 minutes to about 3 hours. The washcoat loading after calcination can be determined through calculation of the weight difference between the coated and uncoated substrate. As will be apparent to those of skill in the art, the washcoat loading can be modified by altering the slurry rheology. In addition, the deposition process including coating, drying and calcining to generate a washcoat can be repeated as needed to build a layer to the desired loading level or thickness, which means more than one washcoat may be applied.

In some embodiments, the layered catalytic article according to the present invention may further comprise a functional layer applied via a “dry coating” method in which one or more functional materials are applied via a gas phase carrier without using any liquid carrier. For those layered catalytic articles, the substrate is especially wall-flow substrate and the functional layer is the outermost on the porous walls of the substrate.

According to another aspect according to the present invention, an exhaust treatment system is provided which comprises the layered catalytic article as described herein located downstream of an internal combustion. The layered catalytic article may be located downstream of an internal combustion engine, especially a gasoline engine, in a close-coupled position, in a position downstream of the close-coupled position, or both.

According to a further aspect according to the present invention, a method for treating an exhaust stream is provided, which includes contacting the exhaust stream with the layered catalytic article or the exhaust treatment system as described herein.

The terms “exhaust stream”, “exhaust gas” and the like refer to any engine effluent gas that may also contain solid or liquid particulate matter.

The layered catalytic article according to the present invention is particularly useful for abatement of hydrocarbons, carbon monoxide and nitrogen oxides in an exhaust stream from an internal combustion engine, especially a gasoline engine.

### Embodiments

Various embodiments are listed below. It will be understood that the embodiments listed below may be combined with all aspects and other embodiments in accordance with the scope of the invention.
1. A layered catalytic article, particularly useful for three-way conversion, which comprises
a) a top layer comprising a palladium (Pd) component, a platinum (Pt) component and a rhodium (Rh) component, wherein the palladium component, the platinum component and the rhodium component are present in supported forms, and wherein at least part of the platinum component and at least part of the rhodium component are supported together on one or more supports;
b) a bottom layer comprising a palladium component in a supported form as the only platinum group metal component; and
c) a substrate, on which the top layer and bottom layer are carried,
wherein the palladium components are loaded in the top layer and in the bottom layer at a ratio of higher than 1:1, calculated as palladium element.
2. The layered catalytic article according to embodiment 1, wherein the top layer is substantially free of any PGMs other than Pd, Pt and Rh.
3. The layered catalytic article according to embodiment 1 or 2, wherein the at least part of the platinum component and the at least part of the rhodium component in the top layer are supported together on one or more supports other than alumina.
4. The layered catalytic article according to any of preceding embodiments, wherein the at least part of the platinum component and the at least part of the rhodium component are supported together on one or more supports selected from ceria doped alumina, zirconia doped alumina, ceria-zirconia doped alumina, lanthana-zirconia doped alumina, baria-lanthana doped alumina, baria-lanthana-neodymia doped alumina, zirconia, lanthana doped zirconia, yttria doped zirconia, neodymia doped zirconia, praseodymia doped zirconia, titania doped zirconia, titania-lanthana doped zirconia, lanthana-yttria doped zirconia, ceria, ceria-zirconia composite oxide and rare earth-stabilized ceria-zirconia composite oxide.
5. The layered catalytic article according to any of preceding embodiments, wherein the at least part of the platinum component and the at least part of the rhodium component are supported together on one or more supports selected from ceria doped alumina, ceria-zirconia composite oxide and rare earth-stabilized ceria-zirconia composite oxide.
6. The layered catalytic article according to any of preceding embodiments, wherein at least 70%, preferably all of the platinum component is supported together with the at least part of the rhodium component on one or more supports in the top layer.
7. The layered catalytic article according to any of preceding embodiments, wherein at least 10%, at least 30% or at least 50% of the rhodium component is supported together with the platinum component on one or more supports in the top layer.
8. The layered catalytic article according to any of preceding embodiments, wherein the palladium components are loaded in the top layer and in the bottom layer at a ratio of higher than 1:1 and no greater than 10:1, preferably in the range of 1.2:1 to 6:1, more preferably 1.5:1 to 4:1, most preferably in the range of 2:1 to 4:1, calculated as palladium element.
9. The layered catalytic article according to any of preceding embodiments, which comprises:
a) a top layer comprising a palladium component, a platinum component and a rhodium component, wherein the palladium component, the platinum component and the rhodium component are present in supported forms, and wherein all of the platinum component and at least part of the rhodium component are supported together on one or more supports selected from ceria doped alumina, zirconia doped alumina, ceria-zirconia doped alumina, lanthana-zirconia doped alumina, baria-lanthana doped alumina, baria-lanthana-neodymia doped alumina, zirconia, lanthana doped zirconia, yttria doped zirconia, neodymia doped zirconia, praseodymia doped zirconia, titania doped zirconia, titania-lanthana doped zirconia, lanthana-yttria doped zirconia, ceria, ceria-zirconia composite oxide and rare earth-stabilized ceria-zirconia composite oxide;
b) a bottom layer comprising a palladium component in a supported form as the only platinum group metal component; and
c) a substrate, on which the top layer and bottom layer are carried,
wherein the palladium components are loaded in the top layer and in the bottom layer at a ratio in the range of 1.2:1 to 6:1, preferably 1.5:1 to 4:1, more preferably in the range of 2:1 to 4:1, calculated as palladium element.
10. The layered catalytic article according to any of preceding embodiments, which comprises:
a) a top layer comprising a palladium component, a platinum component and a rhodium component, wherein the palladium component, the platinum component and the rhodium component are present in supported forms, and wherein all of the platinum component and at least part of the rhodium component are supported together on one or more supports selected from ceria doped alumina, ceria-zirconia composite oxide and rare earth-stabilized ceria-zirconia composite oxide;
b) a bottom layer comprising a palladium component in a supported form as the only platinum group metal component; and
c) a substrate, on which the top layer and bottom layer are carried,
wherein the palladium components are loaded in the top layer and in the bottom layer at a ratio in the range of 1.5:1 to 4:1, most preferably in the range of 2:1 to 4:1, calculated as palladium element.
11. The layered catalytic article according to any of preceding embodiments, wherein the weight ratio of the palladium component to the platinum component comprised in the layered catalytic article is in the range of 1:1 to 10:1, for example 2.0:1 to 9:1, 2.1:1 to 6:1, or 2.3:1 to 5:1, or 2.3:1 to 4:1, calculated as palladium and platinum elements.
12. The layered catalytic article according to any of preceding embodiments, wherein the weight ratio of the rhodium component to the sum of the palladium and platinum components in the layered catalytic article is in the range of 2:3 to 1:200, 1:2 to 1:50, 1:3 to 1:20, or 1:3 to 1:10, calculated as respective elements.
13. The layered catalytic article according to any of preceding embodiments, wherein the weight ratio of the palladium component to the platinum component to the rhodium component in the layered catalytic article is in the range of 1:1:1 to 10:1:0.2, 2:1:1 to 9:1:0.3, or 2:1:1 to 5:1:0.5, calculated as respective elements.
14. The layered catalytic article according to any of preceding embodiments, wherein the platinum group metals are in the top layer in an amount of 1 to 250 g/ft³, 5 to 150 g/ft³, or 5 to 100 g/ft³, calculated as the sum of respective elements, and/or the palladium component is loaded in the bottom layer in an amount of 0.5 to 200 g/ft³, 1 to 150 g/ft³, or 2 to 100 g/ft³, calculated as palladium element.
15. The layered catalytic article according to any of preceding embodiments, wherein the bottom layer is applied on the substrate and the top layer is applied on the bottom layer without any intermediate layer.
16. The layered catalytic article according to any of preceding embodiments, wherein the substrate is flow-through substrate or wall-flow substrate.
17. Use of the layered catalytic article according to any of embodiments 1 to 16 for abatement of hydrocarbons, carbon monoxide and nitrogen oxides in an exhaust stream.
18. An exhaust treatment system, which comprises the layered catalytic article according to any of embodiments 1 to 16 located downstream of an internal combustion engine, especially a gasoline engine.
19. The exhaust treatment system according to embodiment 18, wherein the layered catalytic article is located downstream of an internal combustion engine in a close-coupled position, in an underfloor position, or both.
20. The exhaust treatment system according to embodiment 18 or 19, wherein the layered catalytic article is followed directly or indirectly by a four-way catalytic converter.
21. A method for treating an exhaust stream, which includes contacting the exhaust stream with the layered catalytic article according to any of embodiments 1 to 16 or the exhaust treatment system according to any of embodiments 18 to 20.
22. The method according to embodiment 21, wherein the layered catalytic article is particularly useful for abatement of hydrocarbons, carbon monoxide and nitrogen oxides in an exhaust stream from internal combustion engine, especially a gasoline engine.

### Examples

Aspects of the present invention will be more fully illustrated by the following Examples, which are set forth to illustrate certain aspects of the present invention and are not to be construed as limiting thereof.

### Example 1 Preparation of a Layered Bi-Metal Catalytic Article (Reference, BMC-1, Pt/Pd/Rh 0/50/10, g/ft³)

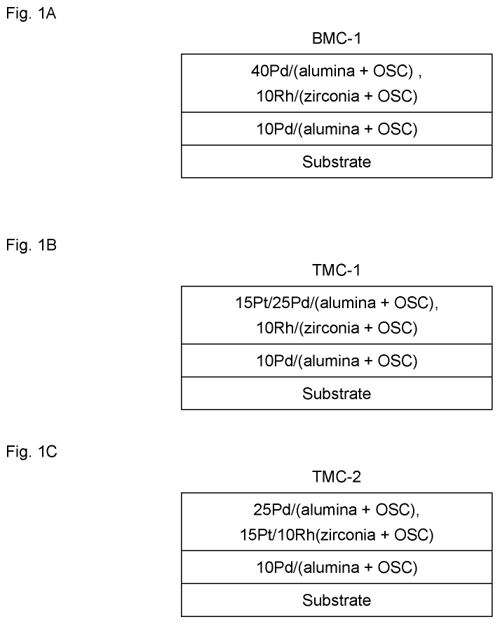

A catalytic article comprising a bottom coat having palladium (Pd) as the only PGM and a top coat having palladium (Pd) and rhodium (Rh) as the PGMs was prepared. A schematic representation of this catalytic article is provided in FIG. 1A.

Bottom Coat Slurry: 18.1 grams of 20% aqueous palladium nitrate solution, 109 grams of alumina and 822 grams of ceria-zirconia (50% zirconia) were mixed with water and then milled to a D₉₀ of below 18 μm. The pH was adjusted around 4.0 by addition of acetic acid, and then 18 grams of alumina binder was added.

### Top Coat Slurry:

A first component was prepared by impregnating 45.29 grams of 20% aqueous palladium nitrate solution onto 240 grams of alumina and 335 grams of ceria-zirconia (50% zirconia) via incipient wetness impregnation. This step was followed by drying at 150° C. for 1 hour and then calcination at 500° C. for 2 hours to allow PGM fixation on the supports. The product was mixed with water and then milled to a D₉₀ of below 18 μm.

A second component was prepared by impregnating 22.65 grams of 10% aqueous rhodium nitrate solution onto 144 grams of zirconia and 241 grams of ceria-zirconia (70% zirconia) via incipient wetness impregnation. The product was mixed with water and then milled to a D₉₀ of below 18 μm.

The two components in form of slurries were blended. The pH was adjusted around 8.0 by addition of barium hydroxide and nitric acid, and then 20 grams of alumina binder was added. The bottom coat slurry was coated onto a 600/2 (cpsi/mils) flow-through ceramic substrate with diameter of 132.1 mm and length of 50 mm, dried at 150° C. for 1 hour and then calcined at 500° C. for 2 hours. The bottom coat was obtained with a washcoat loading of 1.5 g/in³ and the Pd loading of the bottom coating is 10 g/ft³. The top coat slurry was then applied, dried at 150° C. for 1 hour and then calcined at 500° C. for 2 hours. The top coat was obtained with a washcoat loading of 2.5 g/in³ and the PGM loading of the top coat consists of 40 g/ft³ Pd and 10 g/ft³ Rh.

Example 2 Preparation of a Layered Tri-metal Catalytic Article (Reference, TMC-1, Pt/Pd/Rh 15/35/10, g/ft³) A catalytic article comprising a bottom coat having palladium (Pd) as the only PGM and a top coat having palladium (Pd), platinum (Pt) and rhodium (Rh) as the PGMs was prepared. A schematic representation of this catalytic article is provided in FIG. 1B. This catalytic article (TMC-1) represents a variant of the catalytic article (BMC-1) by simple replacement of 30% Pd with Pt in the top coat.

Bottom Coat Slurry: 18.1 grams of 20% aqueous palladium nitrate solution, 109 grams of alumina and 822 grams of ceria-zirconia (50% zirconia) were mixed with water and then milled to a D₉₀ of below 18 μm. The pH was adjusted around 4.0 by addition of acetic acid, and then 18 grams of alumina binder was added.

### Top Coat Slurry:

A first component was prepared by firstly impregnating 20.34 grams of 16% aqueous hexahydroxyplatinic acid diethanolamine salt solution on 240 grams of alumina and 335 grams of ceria-zirconia (50% zirconia) and secondly impregnating 28.31 grams of 20% aqueous palladium nitrate solution, via incipient wetness impregnation. This step was followed by drying at 150° C. for 1 hour and then calcination at 500° C. for 2 hours to allow PGM fixation on the supports. The product was mixed with water and then milled to a D₉₀ of below 18 μm.

A second component was prepared by impregnating 22.65 grams of 10% aqueous rhodium nitrate solution onto 144 grams of zirconia and 241 grams of ceria-zirconia (70% zirconia) via incipient wetness impregnation. The product was mixed with water and then milled to a D₉₀ of below 18 μm.

The two components in form of slurries were blended. The pH was adjusted around 8.0 by addition of barium hydroxide and nitric acid, and then 20 grams of alumina binder was added.

The bottom coat slurry was coated onto a 600/2 (cpsi/mils) flow-through ceramic substrate with diameter of 132.1 mm and length of 50 mm, dried at 150° C. for 1 hour and then calcined at 500° C. for 2 hours. The bottom coat was obtained with a washcoat loading of 1.5 g/in³ and the Pd loading of the bottom coating is 10 g/ft³. The top coat slurry was then applied, dried at 150° C. for 1 hour and then calcined at 500° C. for 2 hours. The top coat was obtained with a washcoat loading of 2.5 g/in³ and the PGM loading of the top coat consists of 15 g/ft³ Pt, 25 g/ft³ Pd and 10 g/ft³ Rh.

### Example 3 Preparation of a Layered Tri-Metal Catalytic Article (Inventive, TMC-2, Pt/Pd/Rh 15/35/10, g/ft³)

A catalytic article comprising a bottom coat having palladium (Pd) as the only PGM and a top coat having palladium (Pd), platinum (Pt) and rhodium (Rh) as the PGMs was prepared. The platinum (Pt) and rhodium (Rh) in the top coat are supported together. A schematic representation of this catalytic article is provided in FIG. 1C.

Bottom Coat Slurry: 18.1 grams of 20% aqueous palladium nitrate solution, 109 grams of alumina and 822 grams of ceria-zirconia (50% zirconia) were mixed with water and then milled to a D₉₀ of below 18 μm. The pH was adjusted around 4.0 by addition of acetic acid, and then 18 grams of alumina binder was added.

### Top Coat Slurry:

A first component was prepared by impregnating 28.31 grams of 20% aqueous palladium nitrate solution on 240 grams of alumina and 335 grams of ceria-zirconia (50% zirconia) via incipient wetness impregnation. This step was followed by drying at 150° C. for 1 hour and then calcination at 500° C. for 2 hours to allow PGM fixation on the supports. The product was mixed with water and then milled to a D₉₀ of below 18 μm.

A second component was prepared by firstly impregnating 20.34 grams of 16% aqueous hexahydroxyplatinic acid diethanolamine salt solution onto 144 grams of zirconia and 241 grams of ceria-zirconia (70% zirconia) and secondly impregnating 22.65 grams of 10% aqueous rhodium nitrate solution, via incipient wetness impregnation. The product was mixed with water and then milled to a D₉₀ of below 18 μm.

The two components in form of slurries were blended. The pH was adjusted around 8.0 by addition of barium hydroxide and nitric acid, and then 20 grams of alumina binder was added.

The bottom coat slurry was coated onto a 600/2 (cpsi/mils) flow-through ceramic substrate with diameter of 132.1 mm and length of 50 mm, dried at 150° C. for 1 hour and then calcined at 500° C. for 2 hours. The bottom coat was obtained with a washcoat loading of 1.5 g/in³ and the Pd loading of the bottom coating is 10 g/ft³. The top coat slurry was then applied, dried at 150° C. for 1 hour and then calcined at 500° C. for 2 hours. The top coat was obtained with a washcoat loading of 2.5 g/in³ and the PGM loading of the top coat consists of 15 g/ft³ Pt, 25 g/ft³ Pd and 10 g/ft³ Rh.

### Example 4: Preparation of a Layered Tri-Metal Catalytic Article (Inventive, TMC-3, Pt/Pd/Rh 15/35/4, g/ft³)

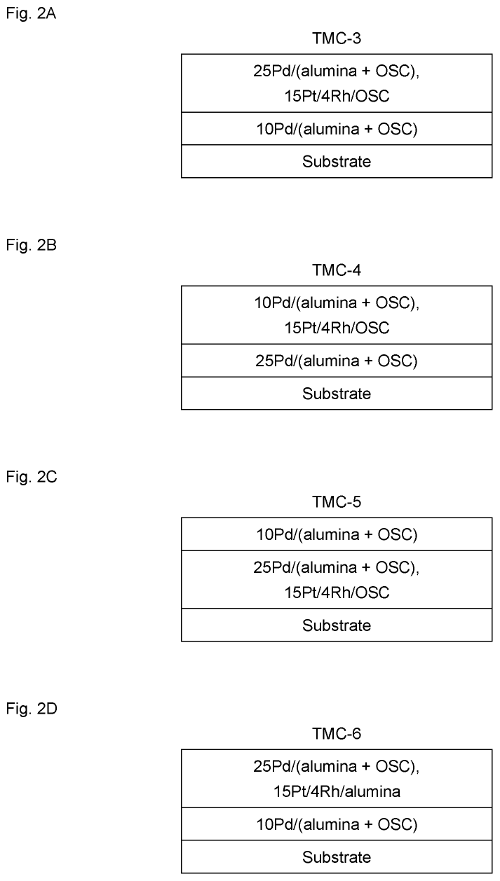

A catalytic article comprising a bottom coat having palladium (Pd) as the only PGM and a top coat having palladium (Pd), platinum (Pt) and rhodium (Rh) as the PGMs was prepared. A schematic representation of this catalytic article is provided in FIG. 2A.

Bottom Coat Slurry: 18.1 grams of 20% aqueous palladium nitrate solution, 109 grams of alumina and 822 grams of ceria-zirconia (50% zirconia) were mixed with water and then milled to a D₉₀ of below 18 μm. The pH was adjusted around 4.0 by addition of acetic acid, and then 18 grams of alumina binder was added.

### Top Coat Slurry:

A first component was prepared by impregnating 28.31 grams of 20% aqueous palladium nitrate solution on 240 grams of alumina and 335 grams of ceria-zirconia (50% zirconia) via incipient wetness impregnation. This step was followed by drying at 150° C. for 1 hour and then calcination at 500° C. for 2 hours to allow PGM fixation on the supports. The product was mixed with water and then milled to a D₉₀ of below 18 μm.

A second component was prepared by firstly impregnating 20.34 grams of 16% aqueous hexahydroxyplatinic acid diethanolamine salt solution onto 385 grams of ceria-zirconia (75% zirconia) and secondly impregnating 9.06 grams of 10% aqueous rhodium nitrate solution, via incipient wetness impregnation. The product was mixed with water and then milled to a D₉₀ of below 18 μm.

The two components in form of slurries were blended. The pH was adjusted around 8.0 by addition of barium hydroxide and nitric acid, and then 20 grams of alumina binder was added.

The bottom coat slurry was coated onto a 750/2 (cpsi/mils) flow-through ceramic substrate with diameter of 25.4 mm and length of 76.2 mm, dried at 150° C. for 1 hour and then calcined at 500° C. for 2 hours. The bottom coat was obtained with a washcoat loading of 1.5 g/in³ and the Pd loading of the bottom coating is 10 g/ft³. The top coat slurry was then applied, dried at 150° C. for 1 hour and then calcined at 500° C. for 2 hours. The top coat was obtained with a washcoat loading of 2.5 g/in³ and the PGM loading of the top coat consists of 15 g/ft³ Pt, 25 g/ft³ Pd and 4 g/ft³ Rh.

### Example 5: Preparation of a Layered Tri-Metal Catalytic Article (Comparative, TMC-4, Pt/Pd/Rh 15/35/4, g/ft³)

A catalytic article comprising a bottom coat having palladium (Pd) as the only PGM and a top coat having palladium (Pd), platinum (Pt) and rhodium (Rh) as the PGMs was prepared. A schematic representation of this catalytic article is provided in FIG. 2B.

Bottom Coat Slurry: 28.31 grams of 20% aqueous palladium nitrate solution, 109 grams of alumina and 822 grams of ceria-zirconia (50% zirconia) were mixed with water and then milled to a D₉₀ of below 18 μm. The pH was adjusted around 4.0 by addition of acetic acid, and then 18 grams of alumina binder was added.

### Top Coat Slurry:

A first component was prepared by impregnating 18.10 grams of 20% aqueous palladium nitrate solution on 240 grams of alumina and 335 grams of ceria-zirconia (50% zirconia) via incipient wetness impregnation. This step was followed by drying at 150° C. for 1 hour and then calcination at 500° C. for 2 hours to allow PGM fixation on the supports. The product was mixed with water and then milled to a D₉₀ of below 18 μm.

A second component was prepared by firstly impregnating 20.34 grams of 16% aqueous hexahydroxyplatinic acid diethanolamine salt solution onto 385 grams of ceria-zirconia (75% zirconia) and secondly impregnating 9.06 grams of 10% aqueous rhodium nitrate solution, via incipient wetness impregnation. The product was mixed with water and then milled to a D₉₀ of below 18 μm.

The two components in form of slurries were blended. The pH was adjusted around 8.0 by addition of barium hydroxide and nitric acid, and then 20 grams of alumina binder was added.

The bottom coat slurry was coated onto a 750/2 (cpsi/mils) flow-through ceramic substrate with diameter of 25.4 mm and length of 76.2 mm, dried at 150° C. for 1 hour and then calcined at 500° C. for 2 hours. The bottom coat was obtained with a washcoat loading of 1.5 g/in³ and the Pd loading of the bottom coating is 25 g/ft³. The top coat slurry was then applied, dried at 150° C. for 1 hour and then calcined at 500° C. for 2 hours. The top coat was obtained with a washcoat loading of 2.5 g/in³ and the PGM loading of the top coat consists of 15 g/ft³ Pt, 10 g/ft³ Pd and 4 g/ft³ Rh.

### Example 6: Preparation of a Layered Tri-Metal Catalytic Article (Comparative, TMC-5, Pt/Pd/Rh, 15/35/4, g/ft³)

A catalytic article comprising a bottom coat having palladium (Pd), platinum (Pt) and rhodium (Rh) as the PGMs and a top coat having palladium (Pd) as the only PGM was prepared. A schematic representation of this catalytic article is provided in FIG. 2C.

### Bottom Coat Slurry:

A first component was prepared by impregnating 28.31 grams of 20% aqueous palladium nitrate solution on 240 grams of alumina and 335 grams of ceria-zirconia (50% zirconia) via incipient wetness impregnation. This step was followed by drying at 150° C. for 1 hour and then calcination at 500° C. for 2 hours to allow PGM fixation on the supports. The product was mixed with water and then milled to a D₉₀ of below 18 μm.

A second component was prepared by firstly impregnating 20.34 grams of 16% aqueous hexahydroxyplatinic acid diethanolamine salt solution onto 385 grams of ceria-zirconia (75% zirconia) and secondly impregnating 9.06 grams of 10% aqueous rhodium nitrate solution, via incipient wetness impregnation. The product was mixed with water and then milled to a D₉₀ of below 18 μm.

The two components in form of slurries were blended. The pH was adjusted around 8.0 by addition of barium hydroxide and nitric acid, and then 20 grams of alumina binder was added.

### Top Coat Slurry:

18.1 grams of 20% aqueous palladium nitrate solution, 109 grams of alumina and 822 grams of ceria-zirconia (50% zirconia) were mixed with water and then milled to a D₉₀ of below 18 μm. The pH was adjusted around 4.0 by addition of acetic acid, and then 18 grams of alumina binder was added.

The bottom coat slurry was coated onto a 750/2 (cpsi/mils) flow-through ceramic substrate with diameter of 25.4 mm and length of 76.2 mm, dried at 150° C. for 1 hour and then calcined at 500° C. for 2 hours. The bottom coat was obtained with a washcoat loading of 2.5 g/in³ and the PGM loading of the bottom coat consists of 15 g/ft³ Pt, 25 g/ft³ Pd and 4 g/ft³ Rh. The top coat slurry was then applied, dried at 150° C. for 1 hour and then calcined at 500° C. for 2 hours. The top coat was obtained with a washcoat loading of 1.5 g/in³ and the Pd loading of the bottom coating is 10 g/ft³.

### Example 7: Preparation of a Layered Tri-Metal Catalytic Article (Comparative, TMC-6, Pt/Pd/Rh 15/35/4, g/ft³)

A catalytic article comprising a bottom coat having palladium (Pd) as the only PGM and a top coat having palladium (Pd), platinum (Pt) and rhodium (Rh) as the PGMs was prepared. A schematic representation of this catalytic article is provided in FIG. 2D.

Bottom Coat Slurry: 18.1 grams of 20% aqueous palladium nitrate solution, 109 grams of alumina and 822 grams of ceria-zirconia (50% zirconia) were mixed with water and then milled to a D₉₀ of below 18 μm. The pH was adjusted around 4.0 by addition of acetic acid, and then 18 grams of alumina binder was added.

### Top Coat Slurry:

A first component was prepared by impregnating 28.31 grams of 20% aqueous palladium nitrate solution on 240 grams of alumina and 335 grams of ceria-zirconia (50% zirconia) via incipient wetness impregnation. This step was followed by drying at 150° C. for 1 hour and then calcination at 500° C. for 2 hours to allow PGM fixation on the supports. The product was mixed with water and then milled to a D₉₀ of below 18 μm.

A second component was prepared by firstly impregnating 20.34 grams of 16% aqueous hexahydroxyplatinic acid diethanolamine salt solution onto 385 grams of alumina and secondly impregnating 9.06 grams of 10% aqueous Rh-nitrate solution, via incipient wetness impregnation. The product was mixed with water and then milled to a D₉₀ of below 18 μm.

The two components in form of slurries were blended. The pH was adjusted around 8.0 by addition of barium hydroxide and nitric acid, and then 20 grams of alumina binder was added.

The bottom coat slurry was coated onto a 750/2 (cpsi/mils) flow-through ceramic substrate with diameter of 25.4 mm and length of 76.2 mm, dried at 150° C. for 1 hour and then calcined at 500° C. for 2 hours. The bottom coat was obtained with a washcoat loading of 1.5 g/in³ and the Pd loading of the bottom coating is 10 g/ft³. The top coat slurry was then applied, dried at 150° C. for 1 hour and then calcined at 500° C. for 2 hours. The top coat was obtained with a washcoat loading of 2.5 g/in³ and the PGM loading of the top coat consists of 15 g/ft³ Pt, 25 g/ft³ Pd and 4 g/ft³ Rh.

### Example 8: Preparation of a Layered Tri-Metal Catalytic Article (Inventive, TMC-7, Pt/Pd/Rh 15/35/4, g/ft³)

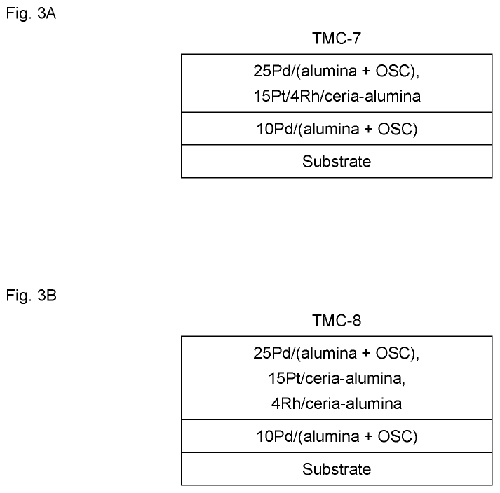

A catalytic article comprising a bottom coat having palladium (Pd) as the only PGM and a top coat having palladium (Pd), platinum (Pt) and rhodium (Rh) as the PGMs was prepared. A schematic representation of this catalytic article is provided in FIG. 3A.

Bottom Coat Slurry: 18.1 grams of 20% aqueous palladium nitrate solution, 109 grams of alumina and 822 grams of ceria-zirconia (50% zirconia) were mixed with water and then milled to a D₉₀ of below 18 μm. The pH was adjusted around 4.0 by addition of acetic acid, and then 18 grams of alumina binder was added.

### Top Coat Slurry:

A first component was prepared by impregnating 28.31 grams of 20% aqueous palladium nitrate solution on 240 grams of alumina and 335 grams of ceria-zirconia (50% zirconia) via incipient wetness impregnation. This step was followed by drying at 150° C. for 1 hour and then calcination at 500° C. for 2 hours to allow PGM fixation on the supports. The product was mixed with water and then milled to a D₉₀ of below 18 μm.

A second component was prepared by firstly impregnating 20.34 grams of 16% aqueous hexahydroxyplatinic acid diethanolamine salt solution onto 385 grams of ceria-alumina (90% alumina) and secondly impregnating 9.06 grams of 10% aqueous rhodium nitrate solution, via incipient wetness impregnation. The product was mixed with water and then milled to a D₉₀ of below 18 μm.

The two components in form of slurries were blended. The pH was adjusted around 8.0 by addition of barium hydroxide and nitric acid, and then 20 grams of alumina binder was added.

The bottom coat slurry was coated onto a 750/2 (cpsi/mils) flow-through ceramic substrate with diameter of 25.4 mm and length of 76.2 mm, dried at 150° C. for 1 hour and then calcined at 500° C. for 2 hours. The bottom coat was obtained with a washcoat loading of 1.5 g/in³ and the Pd loading of the bottom coating is 10 g/ft³. The top coat slurry was then applied, dried at 150° C. for 1 hour and then calcined at 500° C. for 2 hours. The top coat was obtained with a washcoat loading of 2.5 g/in³ and the PGM loading of the top coat consists of 15 g/ft³ Pt, 25 g/ft³ Pd and 4 g/ft³ Rh.

### Example 9: Preparation of a Layered Tri-Metal Catalytic Article (Comparative, TMC-8, Pt/Pd/Rh 15/35/4, g/ft³)

A catalytic article comprising a bottom coat having palladium (Pd) as the only PGM and a top coat having palladium (Pd), platinum (Pt) and rhodium (Rh) as the PGMs was prepared. A schematic representation of this catalytic article is provided in FIG. 3B.

Bottom Coat Slurry: 18.1 grams of 20% aqueous palladium nitrate solution, 109 grams of alumina and 822 grams of ceria-zirconia (50% zirconia) were mixed with water and then milled to a D₉₀ of below 18 μm. The pH was adjusted around 4.0 by addition of acetic acid, and then 18 grams of alumina binder was added.

### Top Coat Slurry:

A first component was prepared by impregnating 28.31 grams of 20% aqueous palladium nitrate solution on 240 grams of alumina and 335 grams of ceria-zirconia (50% zirconia) via incipient wetness impregnation. This step was followed by drying at 150° C. for 1 hour and then calcination at 500° C. for 2 hours to allow PGM fixation on the supports. The product was mixed with water and then milled to a D₉₀ of below 18 μm.

A second component was prepared by impregnating 20.34 grams of 16% aqueous hexahydroxyplatinic acid diethanolamine salt solution onto 257 grams of ceria-alumina (90% alumina) via incipient wetness impregnation. The product was mixed with water and then milled to a D₉₀ of below 18 μm.

A third component was prepared by firstly impregnating 9.06 grams of 10% aqueous rhodium nitrate solution onto 128 grams of ceria-alumina (90% alumina) via incipient wetness impregnation. The product was mixed with water and then milled to a D₉₀ of below 18 μm.

The three components in form of slurries were blended. The pH was adjusted around 8.0 by addition of barium hydroxide and nitric acid, and then 20 grams of alumina binder was added.

The bottom coat slurry was coated onto a 750/2 (cpsi/mils) flow-through ceramic substrate with diameter of 25.4 mm and length of 76.2 mm, dried at 150° C. for 1 hour and then calcined at 500° C. for 2 hours. The bottom coat was obtained with a washcoat loading of 1.5 g/in³ and the Pd loading of the bottom coating is 10 g/ft³. The top coat slurry was then applied, dried at 150° C. for 1 hour and then calcined at 500° C. for 2 hours. The top coat was obtained with a washcoat loading of 2.5 g/in³ and the PGM loading of the top coat consists of 15 g/ft³ Pt, 25 g/ft³ Pd and 4 g/ft³ Rh.

### Example 10: Preparation of a Layered Tri-Metal Catalytic Article (Comparative, TMC-9, Pt/Pd/Rh 15/35/4, g/ft³)

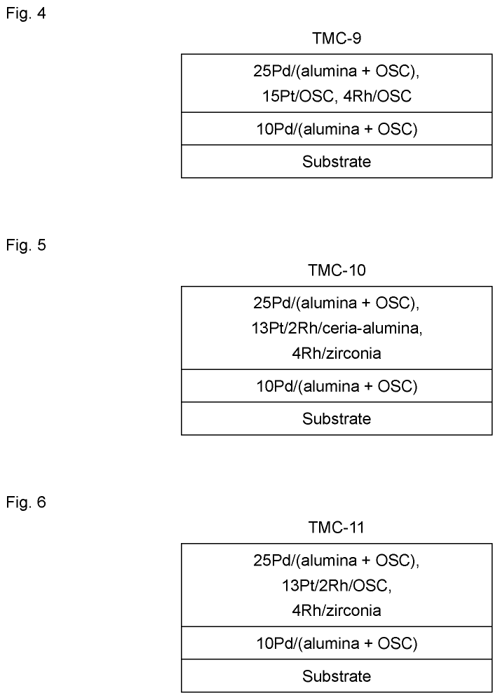

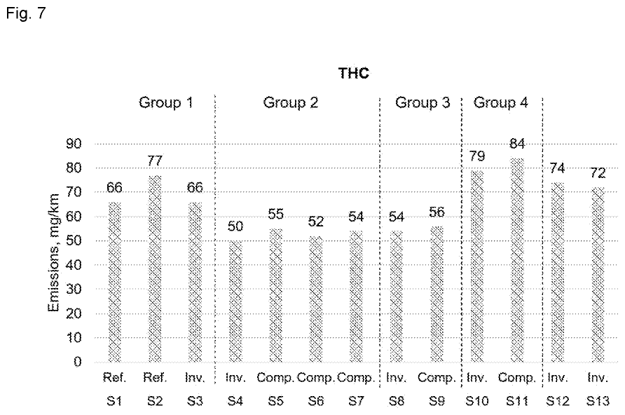

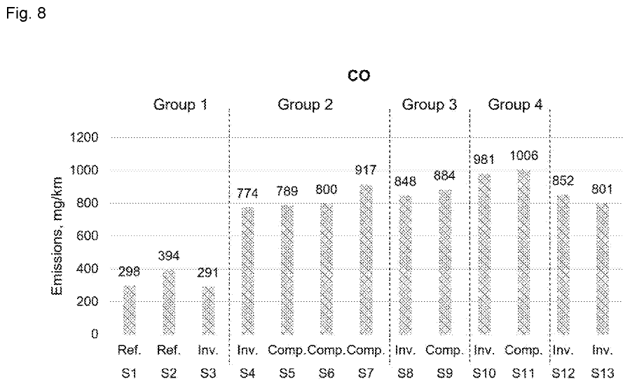

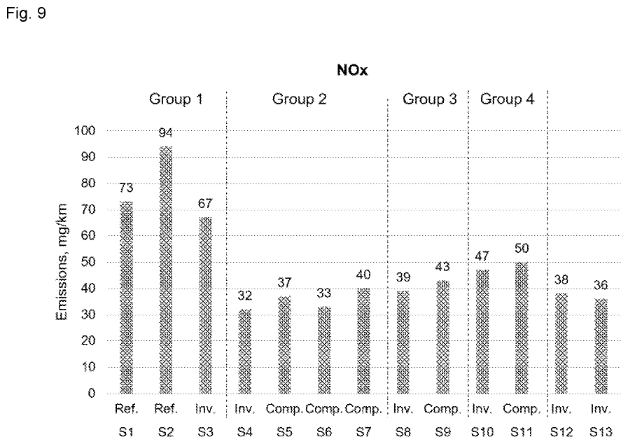

A catalytic article comprising a bottom coat having palladium (Pd) as the only PGM and a top coat having palladium (Pd), platinum (Pt) and rhodium (Rh) as the PGMs was prepared. A schematic representation of this catalytic article is provided in FIG. 4.

### Bottom Coat Slurry:

18.1 grams of 20% aqueous palladium nitrate solution, 109 grams of alumina and 822 grams of ceria-zirconia (50% zirconia) were mixed with water and then milled to a D₉₀ of below 18 μm. The pH was adjusted around 4.0 by addition of acetic acid, and then 18 grams of alumina binder was added.

### Top Coat Slurry:

A first component was prepared by impregnating 28.31 grams of 20% aqueous palladium nitrate solution on 240 grams of alumina and 335 grams of ceria-zirconia (50% zirconia) via incipient wetness impregnation. This step was followed by drying at 150° C. for 1 hour and then calcination at 500° C. for 2 hours to allow PGM fixation on the supports. The product was mixed with water and then milled to a D₉₀ of below 18 μm.

A second component was prepared by impregnating 20.34 grams of 16% aqueous hexahydroxyplatinic acid diethanolamine salt solution onto 257 grams of ceria-zirconia (75% zirconia) via incipient wetness impregnation. The product was mixed with water and then milled to a D₉₀ of below 18 μm.

A third component was prepared by firstly impregnating 9.06 grams of 10% aqueous rhodium nitrate solution onto 128 grams of ceria-zirconia (75% zirconia) via incipient wetness impregnation. The product was mixed with water and then milled to a D₉₀ of below 18 μm.

The three components in form of slurries were blended. The pH was adjusted around 8.0 by addition of barium hydroxide and nitric acid, and then 20 grams of alumina binder was added.

The bottom coat slurry was coated onto a 750/2 (cpsi/mils) flow-through ceramic substrate with diameter of 25.4 mm and length of 76.2 mm, dried at 150° C. for 1 hour and then calcined at 500° C. for 2 hours. The bottom coat was obtained with a washcoat loading of 1.5 g/in³ and the Pd loading of the bottom coating is 10 g/ft³. The top coat slurry was then applied, dried at 150° C. for 1 hour and then calcined at 500° C. for 2 hours. The top coat was obtained with a washcoat loading of 2.5 g/in³ and the PGM loading of the top coat consists of 15 g/ft³ Pt, 25 g/ft³ Pd and 4 g/ft³ Rh.

### Example 11: Preparation of a Layered Tri-Metal Catalytic Article (Inventive, TMC-10, Pt/Pd/Rh 13/35/6, g/ft³)

A catalytic article comprising a bottom coat having palladium (Pd) as the only PGM and a top coat having palladium (Pd), platinum (Pt) and rhodium (Rh) as the PGMs was prepared. A schematic representation of this catalytic article is provided in FIG. 5.

### Bottom Coat Slurry:

18.1 grams of 20% aqueous palladium nitrate solution, 109 grams of alumina and 822 grams of ceria-zirconia (50% zirconia) were mixed with water and then milled to a D₉₀ of below 18 μm. The pH was adjusted around 4.0 by addition of acetic acid, and then 18 grams of alumina binder was added.

### Top Coat Slurry:

A first component was prepared by impregnating 28.31 grams of 20% aqueous palladium nitrate solution on 240 grams of alumina and 335 grams of ceria-zirconia (50% zirconia) via incipient wetness impregnation. This step was followed by drying at 150° C. for 1 hour and then calcination at 500° C. for 2 hours to allow PGM fixation on the supports. The product was mixed with water and then milled to a D₉₀ of below 18 μm.

A second component was prepared by firstly impregnating 17.63 grams of 16% aqueous hexahydroxyplatinic acid diethanolamine salt solution onto 257 grams of ceria-alumina (90% alumina) and secondly impregnating 4.53 grams of 10% aqueous rhodium nitrate solution, via incipient wetness impregnation. The product was mixed with water and then milled to a D₉₀ of below 18 μm.

A third component was prepared by firstly impregnating 9.06 grams of 10% aqueous rhodium nitrate solution onto 128 grams of zirconia via incipient wetness impregnation. The product was mixed with water and then milled to a D₉₀ of below 18 μm.

The three components in form of slurries were blended. The pH was adjusted around 8.0 by addition of barium hydroxide and nitric acid, and then 20 grams of alumina binder was added.

The bottom coat slurry was coated onto a 750/2 (cpsi/mils) flow-through ceramic substrate with diameter of 25.4 mm and length of 76.2 mm, dried at 150° C. for 1 hour and then calcined at 500° C. for 2 hours. The bottom coat was obtained with a washcoat loading of 1.5 g/in³ and the Pd loading of the bottom coating is 10 g/ft³. The top coat slurry was then applied, dried at 150° C. for 1 hour and then calcined at 500° C. for 2 hours. The top coat was obtained with a washcoat loading of 2.5 g/in³ and the PGM loading of the top coat consists of 13 g/ft³ Pt, 25 g/ft³ Pd and 6 g/ft³ Rh.

### Example 12: Preparation of a Layered Tri-Metal Catalytic Article (Inventive, TMC-11, Pt/Pd/Rh 13/35/6, g/ft³)

A catalytic article comprising a bottom coat having palladium (Pd) as the only PGM and a top coat having palladium (Pd), platinum (Pt) and rhodium (Rh) as the PGMs was prepared. A schematic representation of this catalytic article is provided in FIG. 6.

### Bottom Coat Slurry:

18.1 grams of 20% aqueous palladium nitrate solution, 109 grams of alumina and 822 grams of ceria-zirconia (50% zirconia) were mixed with water and then milled to a D₉₀ of below 18 μm. The pH was adjusted around 4.0 by addition of acetic acid, and then 18 grams of alumina binder was added.

### Top Coat Slurry:

A first component was prepared by impregnating 28.31 grams of 20% aqueous palladium nitrate solution on 240 grams of alumina and 335 grams of ceria-zirconia (50% zirconia) via incipient wetness impregnation. This step was followed by drying at 150° C. for 1 hour and then calcination at 500° C. for 2 hours to allow PGM fixation on the supports. The product was mixed with water and then milled to a D₉₀ of below 18 μm.

A second component was prepared by firstly impregnating 17.63 grams of 16% aqueous hexahydroxyplatinic acid diethanolamine salt solution onto 257 grams of ceria-zirconia (75% zirconia) and secondly impregnating 4.53 grams of 10% aqueous rhodium nitrate solution, via incipient wetness impregnation. The product was mixed with water and then milled to a D₉₀ of below 18 μm.

A third component was prepared by firstly impregnating 9.06 grams of 10% aqueous rhodium nitrate solution onto 128 grams of zirconia via incipient wetness impregnation. The product was mixed with water and then milled to a D₉₀ of below 18 μm.

The three components in form of slurries were blended. The pH was adjusted around 8.0 by addition of barium hydroxide and nitric acid, and then 20 grams of alumina binder was added.

The bottom coat slurry was coated onto a 750/2 (cpsi/mils) flow-through ceramic substrate with diameter of 25.4 mm and length of 76.2 mm, dried at 150° C. for 1 hour and then calcined at 500° C. for 2 hours. The bottom coat was obtained with a washcoat loading of 1.5 g/in³ and the Pd loading of the bottom coating is 10 g/ft³. The top coat slurry was then applied, dried at 150° C. for 1 hour and then calcined at 500° C. for 2 hours. The top coat was obtained with a washcoat loading of 2.5 g/in³ and the PGM loading of the top coat consists of 13 g/ft³ Pt, 25 g/ft³ Pd and 6 g/ft³ Rh.

### Example 13 Catalytic Performance Test

The catalytic article samples are summarized in Table 1 were aged under condition 1) or condition 2):
1) exothermically aging on an GM 8.1 L V8 engine at an inlet temperature of 875° C.;
2) aging at 1050° C. under an alternating lean/rich atmosphere (lean: 3 vol % O₂, 10 vol % H₂O and balance of N₂; rich: 1 vol % H₂, 3 vol % CO, 10 vol % H₂O and balance of N₂, alternating every 5 mins).

TABLE 1

| Sample | Composition | Aging condition | Aging Time (h) |
|---|---|---|---|
| S1 | BMC-1 (Ex. 1) | 1) | 100 |
| S2 | TMC-1 (Ex. 2) | | |
| S3 | TMC-2 (Ex. 3) | | |
| S4 | TMC-3 (Ex. 4) | 2) | 12 |
| S5 | TMC-4 (Ex. 5) | | |
| S6 | TMC-5 (Ex. 6) | | |
| S7 | TMC-6 (Ex. 7) | | |
| S8 | TMC-7 (Ex. 8) | | |
| S9 | TMC-8 (Ex. 9) | | |
| S10 | TMC-3 (Ex. 4) | 1) | 50 |
| S11 | TMC-9 (Ex. 10) | | |
| S12 | TMC-10 (Ex. 11) | | |
| S13 | TMC-11 (Ex. 12) | | |

The aged samples were tested using the World-wide Light-duty vehicle Test Cycle (WLTC) in accordance with China-6 “Type I” (GB 18352.6-2016). The performance of the test samples was evaluated by measuring the tail-pipe total hydrocarbons (THC), CO and NOx emissions from one test cycle according to China-6 “Type I”:
P1: Low speed phase from 0 to 589 seconds,
P2: Medium speed phase from 590 to 1022 seconds,
P3: High speed phase from 1023 to 1477 seconds, and
P4: Extra high speed phase from 1478 to 1800 seconds.

The samples S1 to S3 were tested on a Daimler 2.0 L engine bench, and the samples S4 to S13 were tested on a bench reactor (Gasoline Vehicle Simulator—GVS) that is capable of simulating vehicle driving conditions under WLTC such as temperature, flow rate (speed), and exhaust gas composition (e.g. CO, HO, NO, H₂O, CO₂).

Each sample was tested three times to provide average test values as the test results which were summarized in Tables 2 to 4.

TABLE 2
Tail-pipe THC emissions

| | Group 1 | | | Group 2 | | | | Group 3 | | Group 4 | | — | — |
|---|---|---|---|---|---|---|---|---|---|---|---|---|---|
| THC, | S1 | S2 | S3 | S4 | S5 | S6 | S7 | S8 | S9 | S10 | S11 | S12 | S13 |
| mg/km | Ref. | Ref. | Inv. | Inv. | Comp. | Comp. | Comp. | Inv. | Comp. | Inv. | Comp. | Inv. | Inv. |
| P1 | 55 | 64 | 55 | 43 | 47 | 45 | 47 | 47 | 48 | 61 | 65 | 55 | 53 |
| P2 | 4 | 5 | 4 | 4 | 5 | 4 | 4 | 4 | 5 | 11 | 12 | 10 | 10 |
| P3 | 3 | 4 | 3 | 2 | 3 | 2 | 2 | 2 | 2 | 5 | 5 | 5 | 5 |
| P4 | 4 | 4 | 4 | 1 | 1 | 1 | 1 | 1 | 1 | 2 | 2 | 4 | 4 |
| Sum | 66 | 77 | 66 | 50 | 55 | 52 | 54 | 54 | 56 | 79 | 84 | 74 | 72 |

TABLE 3
Tail-pipe CO emissions

| | Group 1 | | | Group 2 | | | | Group 3 | | Group 4 | | — | — |
|---|---|---|---|---|---|---|---|---|---|---|---|---|---|
| CO, | S1 | S2 | S3 | S4 | S5 | S6 | S7 | S8 | S9 | S10 | S11 | S12 | S13 |
| mg/km | Ref. | Ref. | Inv. | Inv. | Comp. | Comp. | Comp. | Inv. | Comp. | Inv. | Comp. | Inv. | Inv. |
| P1 | 152 | 207 | 155 | 94 | 98 | 106 | 136 | 123 | 133 | 168 | 187 | 129 | 116 |
| P2 | 34 | 51 | 33 | 160 | 160 | 169 | 207 | 183 | 194 | 225 | 235 | 198 | 178 |
| P3 | 46 | 58 | 46 | 288 | 291 | 289 | 332 | 311 | 315 | 342 | 345 | 292 | 282 |
| P4 | 66 | 78 | 57 | 232 | 240 | 236 | 242 | 231 | 242 | 246 | 239 | 233 | 225 |
| Sum | 298 | 394 | 291 | 774 | 789 | 800 | 917 | 848 | 884 | 981 | 1006 | 852 | 801 |

TABLE 4
Tail-pipe NOx emissions

| | Group 1 | | | Group 2 | | | | Group 3 | | Group 4 | | — | — |
|---|---|---|---|---|---|---|---|---|---|---|---|---|---|
| NOx, | S1 | S2 | S3 | S4 | S5 | S6 | S7 | S8 | S9 | S10 | S11 | S12 | S13 |
| mg/km | Ref. | Ref. | Inv. | Inv. | Comp. | Comp. | Comp. | Inv. | Comp. | Inv. | Comp. | Inv. | Inv. |
| P1 | 42 | 53 | 42 | 28 | 30 | 28 | 30 | 31 | 33 | 39 | 40 | 30 | 29 |
| P2 | 4 | 6 | 3 | 2 | 2 | 2 | 3 | 2 | 3 | 5 | 7 | 4 | 4 |
| P3 | 9 | 11 | 6 | 1 | 1 | 1 | 2 | 1 | 2 | 1 | 1 | 1 | 1 |
| P4 | 18 | 24 | 16 | 1 | 4 | 2 | 5 | 5 | 5 | 2 | 2 | 3 | 2 |
| Sum | 73 | 94 | 67 | 32 | 37 | 33 | 40 | 39 | 43 | 47 | 50 | 38 | 36 |

It is to be understood that the composition of the engine exhaust gas may vary depending on the engine conditions such as hours and distance the engine has run, for example. The samples S1 to S3 were tested under substantially same engine conditions to ensure the inlet exhaust gases for the test samples have substantially same compositions and allow for the comparison of the samples with respect to the measured emissions. Also, the remaining samples in the same group as shown in the Tables were tested under substantially same GVS conditions.

As can be seen from the measured emissions, the reference Sample S2 exhibits about 17% higher THC, about 32% higher CO and about 29% higher NOx emissions compared with the reference Sample S1. The comparison between the test results of Sample S1 and Sample S2 confirmed that incorporation of Pt by simple replacing a portion of Pd in a TWC catalyst will result in worse control of emissions of THC, CO and NOx, as generally recognized in the art. Surprisingly, contrary to the tendency that replacement of Pd with Pt will result in worse emissions, the inventive Sample S3 having a catalytic composition and configuration according to the present invention exhibits about 2% lower CO and about 8% lower NOx emissions, compared with the reference Sample S1.

It can also be seen that the layered tri-metal catalytic article according to the present invention can improve the emission control compared with various variants of the layered tri-metal catalytic article with respect to the catalytic composition and configuration.

The comparative Sample S5, a variant of the inventive Sample S4 obtained by swapping the Pd loading in the bottom coat and top coat, exhibits about 10% higher THC, about 2% higher CO and about 15% higher NOx emissions compared with Sample S4.

The comparative Sample S6, a variant of the inventive Sample S4 obtained by swapping the bottom coat and top coat, exhibits about 4% higher THC, about 3% higher CO and about 3% higher NOx emissions compared with Sample S4.

The comparative Sample S7, a variant of the inventive Sample S4 obtained by replacing the support for supporting Pt and Rh together with alumina, exhibits about 8% higher THC, about 18% higher CO and about 25% higher NOx emissions compared with Sample S4.

The comparative Sample S9, a variant of the inventive Sample S8 obtained by individually supported Pt and Rh, exhibits about 4% higher THC, about 4% higher CO and about 10% higher NOx emissions compared with Sample S8.

The comparative Sample S11, a variant of the inventive Sample S10 obtained by individually supported Pt and Rh, exhibits about 6% higher THC, about 3% higher CO and about 6% higher NOx emissions compared with Sample S10.

Although the invention herein has been described with reference to particular embodiments, it is to be understood that these embodiments are merely illustrative of the principles and applications of the present invention. It will be apparent to those skilled in the art that various modifications and variations can be made to the method and apparatus of the present invention without departing from the spirit and scope of the invention. Thus, it is intended that the present invention include modifications and variations that are within the scope of the appended claims and their equivalents.

1. A layered catalytic article, which comprises
a) a top layer comprising a palladium (Pd) component, a platinum (Pt) component and a rhodium (Rh) component, wherein the palladium component, the platinum component and the rhodium component are present in supported forms, and wherein at least part of the platinum component and at least part of the rhodium component are supported together on one or more supports;
b) a bottom layer comprising a palladium component in a supported form as the only platinum group metal component; and
c) a substrate, on which the top layer and bottom layer are carried,
wherein the palladium components are loaded in the top layer and in the bottom layer at a ratio of higher than 1:1, calculated as palladium element.

2. The layered catalytic article according to claim 1, wherein the top layer is substantially free of any PGMs other than Pd, Pt and Rh.

3. The layered catalytic article according to claim 1, wherein the at least part of the platinum component and the at least part of the rhodium component in the top layer are supported together on one or more supports other than alumina.

4. The layered catalytic article according to claim 1, wherein the at least part of the platinum component and the at least part of the rhodium component are supported together on one or more supports selected from ceria doped alumina, zirconia doped alumina, ceria-zirconia doped alumina, lanthana-zirconia doped alumina, baria-lanthana doped alumina, baria-lanthana-neodymia doped alumina, zirconia, lanthana doped zirconia, yttria doped zirconia, neodymia doped zirconia, praseodymia doped zirconia, titania doped zirconia, titania-lanthana doped zirconia, lanthana-yttria doped zirconia, ceria, ceria-zirconia composite oxide and rare earth-stabilized ceria-zirconia composite oxide.

5. The layered catalytic article according to claim 1, wherein the at least part of the platinum component and the at least part of the rhodium component are supported together on one or more supports selected from ceria doped alumina, ceria-zirconia composite oxide and rare earth-stabilized ceria-zirconia composite oxide.

6. The layered catalytic article according to claim 1, wherein at least 70%, preferably all of the platinum component is supported together with the at least part of the rhodium component on one or more supports in the top layer.

7. The layered catalytic article according to claim 1, wherein at least 10%, at least 30% or at least 50% of the rhodium component is supported together with the platinum component on one or more supports in the top layer.

8. The layered catalytic article according to claim 1, wherein the palladium components are loaded in the top layer and in the bottom layer at a ratio of higher than 1:1 and no greater than 10:1, preferably in the range of 1.2:1 to 6:1, more preferably 1.5:1 to 4:1, most preferably in the range of 2:1 to 4:1, calculated as palladium element.

9. The layered catalytic article according to claim 1, which comprises:
a) a top layer comprising a palladium component, a platinum component and a rhodium component, wherein the palladium component, the platinum component and the rhodium component are present in supported forms, and wherein all of the platinum component and at least part of the rhodium component are supported together on one or more supports selected from ceria doped alumina, zirconia doped alumina, ceria-zirconia doped alumina, lanthana-zirconia doped alumina, baria-lanthana doped alumina, baria-lanthana-neodymia doped alumina, zirconia, lanthana doped zirconia, yttria doped zirconia, neodymia doped zirconia, praseodymia doped zirconia, titania doped zirconia, titania-lanthana doped zirconia, lanthana-yttria doped zirconia, ceria, ceria-zirconia composite oxide and rare earth-stabilized ceria-zirconia composite oxide;
b) a bottom layer comprising a palladium component in a supported form as the only platinum group metal component; and
c) a substrate, on which the top layer and bottom layer are carried,
wherein the palladium components are loaded in the top layer and in the bottom layer at a ratio in the range of 1.2:1 to 6:1, preferably 1.5:1 to 4:1, more preferably in the range of 2:1 to 4:1, calculated as palladium element.

10. The layered catalytic article according to claim 1, which comprises:
a) a top layer comprising a palladium component, a platinum component and a rhodium component, wherein the palladium component, the platinum component and the rhodium component are present in supported forms, and wherein all of the platinum component and at least part of the rhodium component are supported together on one or more supports selected from ceria doped alumina, ceria-zirconia composite oxide and rare earth-stabilized ceria-zirconia composite oxide;
b) a bottom layer comprising a palladium component in a supported form as the only platinum group metal component; and
c) a substrate, on which the top layer and bottom layer are carried,
wherein the palladium components are loaded in the top layer and in the bottom layer at a ratio in the range of 1.5:1 to 4:1, most preferably in the range of 2:1 to 4:1, calculated as palladium element.

11. The layered catalytic article according to claim 1, wherein the weight ratio of the palladium component to the platinum component comprised in the layered catalytic article is in the range of 1:1 to 10:1, for example 2.0:1 to 9:1, 2.1:1 to 6:1, or 2.3:1 to 5:1, calculated as palladium and platinum elements.

12. The layered catalytic article according to claim 1, wherein the bottom layer is applied on the substrate and the top layer is applied on the bottom layer without any intermediate layer.

13. The layered catalytic article according to claim 1, wherein the substrate is flow-through substrate or wall-flow substrate.

14. Use of the layered catalytic article according to claim 1 for abatement of hydrocarbons, carbon monoxide and nitrogen oxides in an exhaust stream.

15. An exhaust treatment system, which comprises the layered catalytic article according to claim 1 located downstream of an internal combustion engine, especially a gasoline engine.

16. The exhaust treatment system according to claim 15, wherein the layered catalytic article is located downstream of an internal combustion engine in a close-coupled position, in an underfloor position, or both.

17. The exhaust treatment system according to claim 15, wherein the layered catalytic article is followed directly or indirectly by a four-way catalytic converter.

18. A method for treating an exhaust stream, which includes contacting the exhaust stream with the layered catalytic article according to claim 1.

19. The method according to claim 18, wherein the layered catalytic article is particularly useful for abatement of hydrocarbons, carbon monoxide and nitrogen oxides in an exhaust stream from internal combustion engine, especially a gasoline engine.
